(19) United States
(12) Patent Application Publication
(10) Pub. No.: US 2022/0391864 A1
(43) Pub. Date: Dec. 8, 2022

(54) Blockchain Lien System for Digital Financial Transactions

(71) Applicant: Jie Tan, Tarrytown, NY (US)

(72) Inventor: Jie Tan, Tarrytown, NY (US)

(21) Appl. No.: 17/339,791

(22) Filed: Jun. 4, 2021

(51) Int. Cl. G06Q 20/10; G06Q 20/06; G06Q 40/02; G06Q 20/38

(52) U.S. Cl. CPC G06Q 20/10; G06Q 20/065; G06Q 40/02; G06Q 20/389

(57) ABSTRACT

A digital lien system that allows a digital asset sender to place a lien and on the digital asset receiver account. The lien action also allows for lenders to place lien on borrower's account. A dispute process is built in for resolve disputes over lien placement. These lien actions afford a second opportunity to reverse an error made by the sender, also provides remedy to prevent frauds that plagues the current digital ledger systems.

### CROSS-REFERENCE

This patent application claims the priority of the U.S. Provisional Patent Application No. 63/185,917, entitled “Digital Lien Recording System for Digital Financial System,” filed on May 7, 2021, the entire of which is thereby incorporated by reference.

### Related Technical Background

In the internet era, because of centralized databases, consumer and private data become controlled by big internet platforms and big tech companies. As a result, individual freedom are threatened through the exploitation of big data collections and exploitation by big tech companies.

Blockchain technology is a peer-to-peer computer network that uses encryption technology on top of the internet, therefore private data can be transferred in an open, distributed manner while users remain anonymous. Blockchain process uses built-in encryption technology that builds a digital ledger that can be programmed to trigger actions automatically but keeps user information encrypted. The digital ledger is made of transactions that is duplicated and distributed across the entire network of computer systems. The digital ledger comprises of a chain of multiple blocks, each block in the chain contains a number of transactions, and every time a new transaction occurs on the blockchain, a record of that transaction is added to every participant's ledger. Transactions are recorded with an immutable cryptographic signature. Thus the chain records form decentralised database managed by multiple participants on the chain. The anonymity of users on the network prevents big tech companies from exploiting user data.

Blockchain technology has been used for secure sharing of medical data, NFT marketplaces, music royalties tracking, cross-border payments, real-time IoT operating systems, personal identity security, anti-money laundering tracking system, supply chain and logistics monitoring. Digital currencies and digital payments are among the most famous applications.

Current blockchain digital financial systems use blockchain technology to conduct peer-to-peer direct transactions without middleman services. Such a system provides a great control and freedom to the users but also places great responsibility on the users. Because of the nature of distributed manner, transactions are completed in a matter of minutes, even seconds, digital assets transaction systems thus have zero tolerance to errors. However, zero error tolerance has greatly hindered these systems being used by those users who are not technology savvy.

The encryption design together with the fast speed of transactions also opens digital asset transactions to be targeted by organized fraudsters and scams. Every year, cryptocurrency holders were defrauded millions and millions of US dollars and there seems to be very little the fraud victims can do. Reporting to police does not really solve the problem because police are overwhelmed with large number of such cases.

Even the people in the digital assets field are tempted by these inherent shortcomings. For example, in May 2021, Sameer Ismail, former Chief Compliance Officer for digital finance platform Uphold, has been accused of misdirecting over $700 k from corporate and user funds. DeFi100, a decentralized finance platform, is accused of a scam after an ostentatious message on their website said, “We scammed you guys, and you can't do s*** about it.” The message sent retail traders into a frenzy. Crime and fraud continue to be a major issue in the crypto industry, with risk and volatility inhibiting participation. Crypto investors can be targeted by fraud events and disinformation from many various angles.

The current digital assets based financial transaction systems seems to have a real design discrepancy that only emphasizes the digital-currency receiver's rights to receive payment fast, but ignores digital currency-sender's right to have risk-free transactions. In the occurrence of fraud, the fraud victim is at the best position to track and catch fraud if the system is designed to protect them.

In traditional fiat cash transactions, people have developed various lien-recording systems to mitigate financial risks. In normal transactions, payment senders, financiers, lenders or service providers before payment are the risk bearers, digital asset based direct payment process must provide a reliable remedy as quickly as possible in order to reverse a fraudulent transaction. In a fraudulent payment transaction, the payer (sender) usually is the one who has the immediate knowledge of the fraud, and is at the best and unique position to act fast to prevent the fraudulent receiver account from removing funds out of its ledger. Decentralized Lien Action offers a solution. Because of the unique digital and computer programmable nature, a built-in digital lien recording system should prevent fraud and increase error tolerance in conducting digital financial transactions, and encourage honest financial behaviors. Digital asset transaction systems are plagued with fraud, these is an urgent need to provide a digital lien system and digital dispute process for digital asset based financial transactions.

### SUMMARY

The present application discloses a digital lien system that allows for lien transactions to mark a specified amount of digital assets in a receiver's account with a lien statement in a decentralized manner and encrypted manner, thus privacy of the users are protected but individual consumer's rights are individually enforced through decentralized computer actions.

In one embodiment, simple digital asset senders are provided the privileges to initiate a PAYER LIEN-TYPE Lien Action and a Dispute Process concerning a particular payment transactions on the blockchain network. Lien Action includes Activation, Bond Action, Lien Statement generation, Lien Placement Action on the receiver account side and Lien Broadcasting Action. Lien Placement action includes creating a Lien Object on the Lien receiver side, recording the Lien Statement to the blockchain ledger and marking the Liened amount of digital assets for Dispute Process, and Lien Broadcasting Action includes steps of initiating Lien Action to subsequent payment receiver accounts. Activation process includes authentication.

In one aspect of the embodiment, the Payment Action includes getting results from Lien Accounting Action that includes scanning for Lien Statements on the account before sending out payments. The Dispute Process includes initiation and placing a bond by the Lien sender. A bond amount in any currency should be placed into an escrow account before the dispute is resolved. A Dispute arbitration committee comprised of licensed arbitrators should be setup on the blockchain ledger network to arbitrate disputes. All related accounts of the related Lien Transactions in dispute as well as the arbitration committee are automatically notified and scheduled for a hearing upon the Dispute Process object being created by Lien sender's ledger and being activated by Bond Action object.

In one aspect of the embodiment, a Lien Release action is activated upon Lien Action object and by Dispute Process, it includes a process of expire Lien Object on the Lien receiver account and expire the Bond Object on the Lien sender account.

In another embodiment, financier accounts, lender accounts, investor accounts, and service provider accounts are provided the privileges to initiate Lien Actions and Dispute Processes in the blockchain network under NON-PAYER LIEN Type that is processed differently as the one available to simple payment senders. Financiers, lenders, investors and service providers are further enabled send Lien Actions to subsequent payment receivers that is required to record the Lien Statement to the titles of the purchased properties. Such Lien Statements on the titles of the purchased properties or services will prevent the subsequent sales of the purchased properties by the borrowers without first clearing the Lien Statements, or will enable collection actions or other legal actions.

The disclosed innovation, in various embodiments, provide one or more of at least the following advantages:
allows a digital payment sender to proactively take immediate actions against fraud. —allows all financiers the ability to secure digital loans without using volatile digital assets as collateral.
allows users to remedy mistakes;
allows the digital asset based transaction systems to inherently protect consumer's rights at the same time of their privacy, so that decentralized blockchain based ledger technology can replace big data exploitation.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1 schematically shows the properties of distributed ledger technology.

FIG. 2 schematically shows the properties of a blockchain ledger.

FIG. 3 schematically shows an example user account address encoding that protects user's identity and privacy.

FIG. 4 schematically shows various example accounts that need to place a claim on the payment receiver in order to protect their interests during the transactions in accordance to this application.

FIG. 5 schematically shows an example Lien system that protects payer's interest during the transactions in accordance to this application.

FIG. 6 schematically shows an example Payment Action that protects payer's interest during the transactions in accordance to this application.

FIG. 7 schematically shows an example Bond Action that initiates Lien Action during the transactions in accordance to this application.

FIG. 8 schematically shows an example Lien Action that protects payer's interest during the transactions in accordance to this application.

FIG. 9 schematically shows an example Lien Release Action that protects payer's interest during the transactions in accordance to this application.

FIG. 10 schematically shows an example Lien Broadcasting Action that prevents fraud in accordance to this application.

FIG. 11 schematically shows an example Lien system in operation in accordance to this application.

FIG. 12 schematically shows an example Dispute Process in accordance to this application.

FIG. 13 schematically shows an example Bond Action in Dispute Process operation in accordance to this application.

FIG. 14 schematically shows example user interface for Lien System in a blockchain digital asset based financial system in accordance to this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition. It is intended that all described functions herein are executable and executed by computer codes or programs on a desktop computer, a laptop computer, a tablet, a cell phone, a smart digital device and any hardware that is capable execute computer programs to do actions controlled by pre-designed instructions stored inside these computer devices or coupled through electronic waves.

The phrase “Payment Transaction” refers to the set of computer actions on a ledger network by which the sender account balance is decreased the payment amount with or without minus a transaction fee and the receiver account balance is increased the payment amount with or without minus a transaction fee.

The phrase “ledger network” refers to a distributed computer programmable database that is consensually shared and synchronized across multiple sites, institutions, or geographies, accessible by multiple people, the participant at each node of the network can access the recordings shared across that network and can own an identical copy of it, any changes or additions made to the ledger are reflected and copied to all participants in a matter of minutes.

The phrase “Lien” refers to a legal right to keep possession of property (claim) belonging to another person until a debt owed by that person is discharged.

The phrase “Lien Action” refers to the computer programs that place a claim/Lien from Lien sender account to Lien Receiver Account.

The phrase “Account” refers to computer network Address sets up on a ledger network that is configured to send and receive digital assets which can be converted into financial instruments, for example, assets that can be traded, or packages of capital that may be traded.

It is contemplated and intended that the design apply to all digital asset networks and systems such as BITCOIN, ETHEREUM, LITECOIN, XINFIN NETWORK, DOGECOIN, etc; for clarity reason, the examples are given based on XRP Ledger system, but an ordinary person in the art would know the variations to modify the coding to apply to other digital assets.

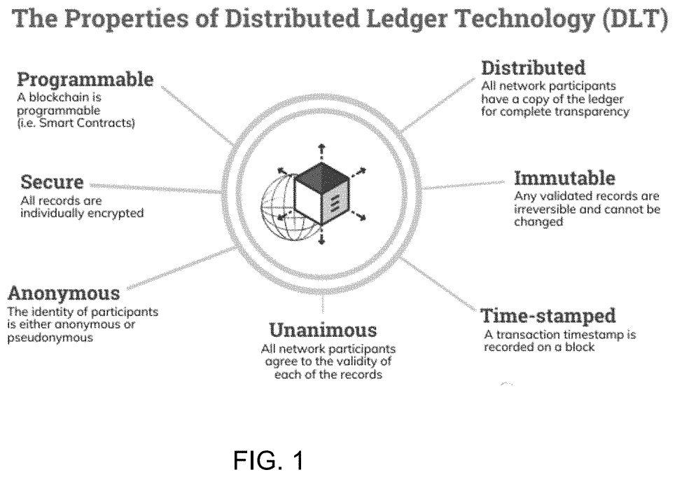

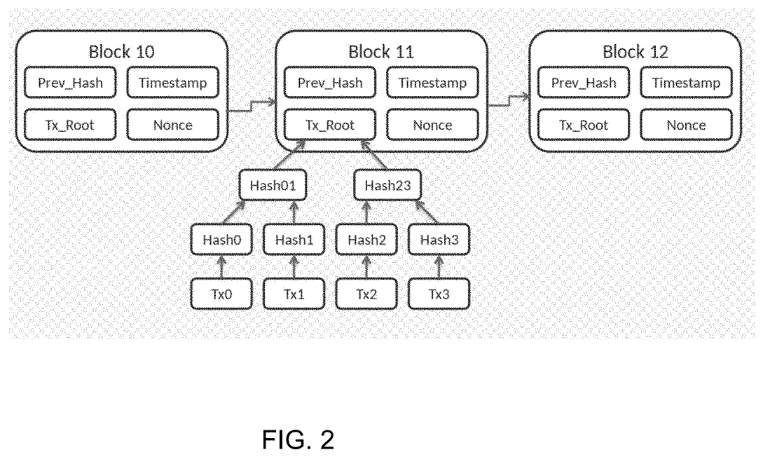

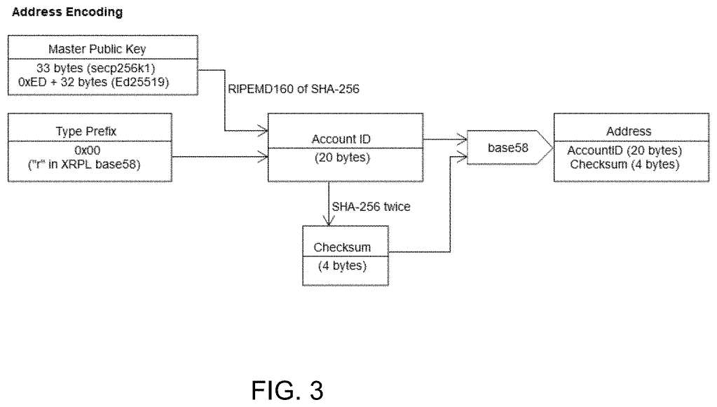

In reference to FIG. 1, blockchain financial systems use blockchain technology to conduct peer-to-peer direct transactions without a centralized platform. In the current crypto ledger network, all records are individual encrypted, the identity of the participants are anonymous, anonymity on the network is essential because it allows for sharing of the records on the entire network. In reference to FIG. 2, a transaction on blockchain financial systems is divided into blocks and each block is encrypted and linked and stamstamped. Subtransactions are recorded at each block so that one single full transaction is non-mutable because it involves multiple blocks. In reference to FIG. 3, account addresses are encrypted during a transaction, in the figure, an example XRP Ledger addresses are encoded using base 58 with the dictionary rpshnaf39wBUDNEGHJKLM4PQRST7VWXYZ2bcdeCg65jkm8oFqiltuvAxyz.

Since the XRP Ledger encodes several types of keys with base 58, it prefixes the encoded data with a one-byte “type prefix” (also called a “version prefix”) to distinguish them. The type prefix causes addresses to usually start with different letters in base 58 format.

Such a system provides its users great control over user data and user information, prevents big tech from data exploitation through their control of the centralized user databases, thus the big tech companies' manipulation and intrusion on individual rights. But such systems also lay great responsibility on the hands of the individual users. In the current system, there is zero tolerance on user's error. If a payment is made by error, the current system does not provide any reversibility, in such case there is almost no remedy available to a user who commits a sin in making an error. As a result, a novice user may lose everything in one mistake. There are even tech and business savvy people who lose money in the moment of misplaced trust. This enabled the current systems plagued with actions of fraudsters.

The inherent irreversibility of crypto transactions comes from the fact that one payment transaction is divided into multiple blocks, To reverse of the transaction requires all multiple blocks of computers to undo the transaction, which is impossible to do. But payment senders need not to be the victims of the irreversibility of the transactions. Because cryptocurrencies are tokens created by computers, compensating payment senders' ricks in sending a irreversible payment to an anonymous address and preventing fraud should be one of the priorities in these systems.

In this application, a lien action system is provided to allow for a crypto payer the privilege and the control in tracking and reversing fraud transactions and a dispute process for resolving transaction related issues.

Traditional Lien system is through filing and recording a Lien Statement on a property or a personal account which is a claim to secure the payment of a debt or performance of some other obligation. The owner of the property, who grants the lien, is referred to as the lienee and the person who has the benefit of the lien is referred to as the lienor or lien holder. The concept of Lien does not require the digital financial payment system to undo the transaction, it simply affords the right to reclaim the payment in case of error or under contract obligations.

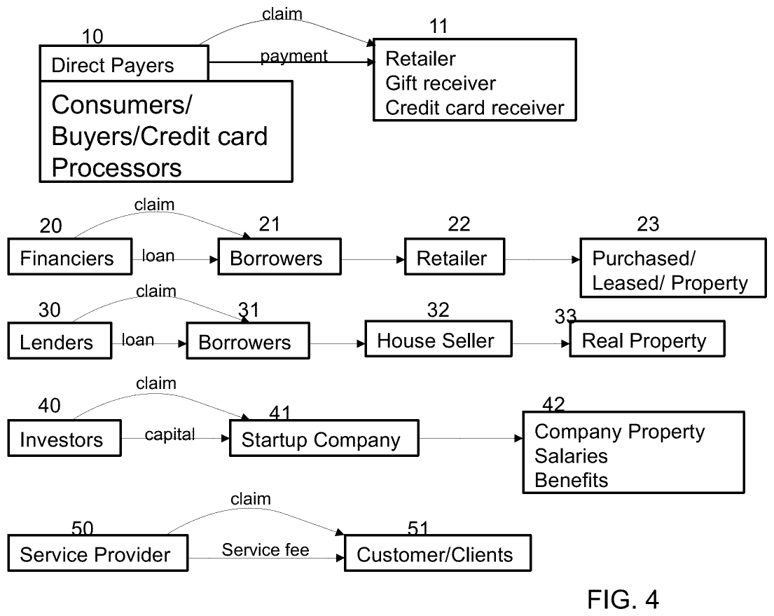

In reference to FIG. 4, there are several example transactions that need to be secured through a lien system. Direct payers 10 need to be able to file a claim on payment receiver 11 when they make a payment transaction that is irreversible by itself. In case of direct payment, payer 10 may include any consumers, buyers, credit card processors, gift giver, etc, and example payment receiver 11 may be a retailer, a gift receiver, a credit card payment receiver, etc. The direct payment transaction is for one total and final exchange of a benefit. On the disclosed digital payment system, immediately upon a successful payment transaction, direct payer 10 automatically becomes a Lien holder and direct payment receiver 11 automatically becomes a Lienee. For this type of transaction, the Lien Type is categorized as Payer-Lien, where the lien holder has immediate right to reclaim the direct payment to be paid back from the Lienee.

Other type of payments may involve contracts and conditions. For example financiers 20 may lend money to a friend borrow 21 where friend borrower 21 may not immediately pay the money back; mortgage lender 30 may lend money to a mortgagee 31 where mortgagee 31 may not immediately pay the money back; investors 40 may invest capital to a startup company 41 where the startup company 41 cannot pay the money back immediately; or service provider 50 provides service to a customer or client 51 where no payment was sent. On the digital payment system, immediately upon a successful payment transaction, payment senders 20, 30, 40 still automatically become Lien holders and payment receivers 21, 31, 41 still automatically becomes Lienees, in which they are enabled to place a lien on the Lienees.

On the digital payment system, immediately upon a successful service being provided, service providers 50 automatically becomes Lien holders and service receivers 51 automatically becomes Lienees, in which they are enabled to place a lien on the Lienees. The Lien Type is categorized as NON-Payer Lien for which the lien holders cannot immediately reclaim payback from the Lienees. However, the Liens are allowed to be passed on and to be placed on subsequent payment receivers from the Lienees, until the subsequent payment receivers place the Lien on Lienee's purchased property 23 or real property 33 or company properties 42. For service provider 50, the Lien Type is also categorized as NON-Payer Lien for which the lien holders may not immediately reclaim payback from the Lienees, the Liens are allowed to be passed on to subsequent payment receivers from the Lienees, until the subsequent payment receivers place the Lien on Lienee's purchased property.

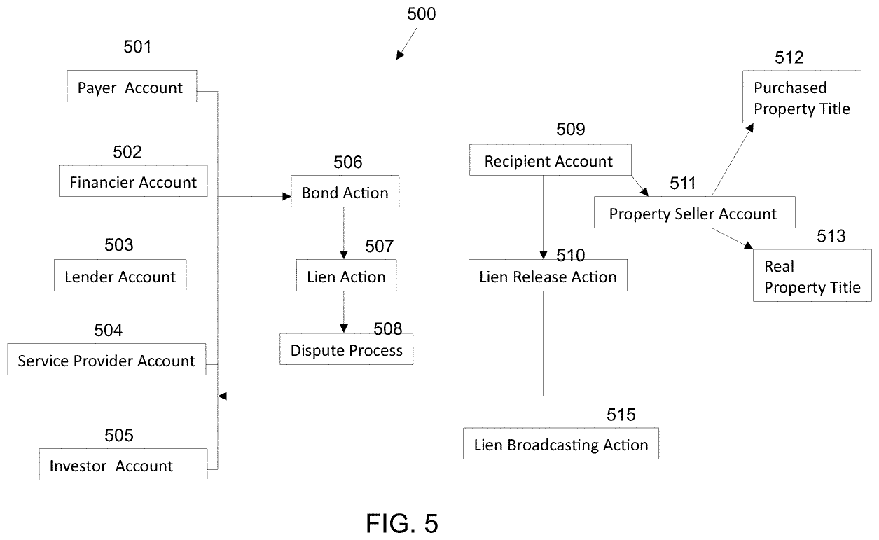

In reference to FIG. 5, an overview of a Lien system 500 is provided. These action elements are provided on every ledgers. On these ledgers, payer account 501, financier account 502, lender account 503, service provider account 504 and investor account 505 interact with Lien Action 507 through Bond Action 506. Lien Action 507 may lead to Dispute Process 508 if recipient account 509 who is liened is not able to release the lien through Lien Release action 510. Lien Action 507 may lead to Lien Broadcasting Action 515 to place liens on other subsequent recipient accounts from recipient account 509 if recipient account as the first lienee does not have sufficient balance to cover the lien. In cases Dispute Process 508 is available for resolving lien issues. Lien Action 507 may require subsequent payment receivers 511, such as a retailer or a property seller, to place a lien on the purchased item by the first lienee in order to request Lien Release Action 510.

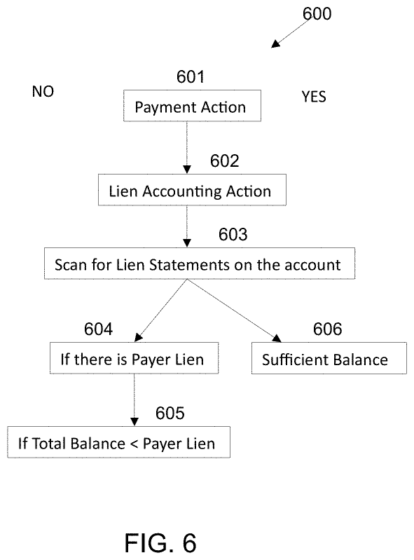

In reference to FIG. 6, in order to immediately enforce a Payer-Lien type, Payment transaction system 600 on a crypto ledger is required to scan for Lien Statement through Lien Accounting Action 602 on the current account before performing a payment transaction from this account. The scanning for Lien Statements may be performed through getting Metadata, getting Memo or a specifically implemented getting Lien Statements method where the ledger root objects conduct a scanning. If there is a Payer-Lien on this account where a lien holder has an immediate claim on the entire balance of the account, the 605 of no payment action is returned to payment action 601. If the current balance is sufficient to cover both the Payer-Lien and the sending amount, the 606 of yes payment action is returned.

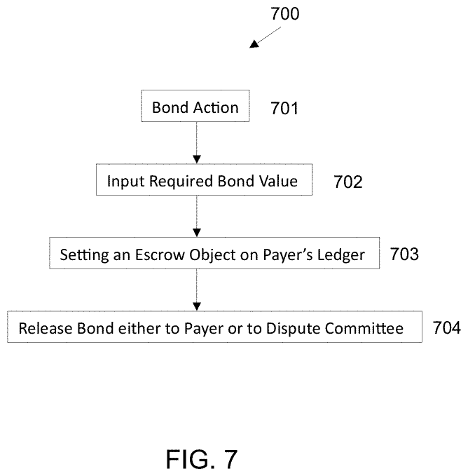

In reference to FIG. 7, Bond Action 700 prevents people from randomly placing a lien to harass against a payment receiver, that the lien holder needs to place a Bond Value in an escrow object that may or may not be returned back to the lien sender in order to initiate Lien Action. When a sender account decides to send a Lien Statement, Bond Action 701 is initiated to require the Lien sender to input an initial Bond value of any currency, for example, $25 paid by credit card, or debit card or a digital asset. The sender account then creates an escrow account object at step 703 to withhold the Bond until the Lien is released or the Lien Action is over. At the 704, Bond is eventually released back to the Lien holder or to a network management address or the account address of the Dispute committee that is set up for resolving Lien disputes on the network.

In the current design of protocol, for example, digital asset XRP, like any other digital asset, is designed as counterparty free, meaning that when someone holds XRP, XRP cannot be frozen by any entity or individual. This feature makes frauds using XRP very difficult to prevent or to resolve. This is probably because digital currency are computer made, if they are designed to be capable of being frozen, they become very liable to be manipulated by hackers or virus. However, using a Bond Action prevents such hostile manipulation on a payment receiver account.

Current XRP ledger offers Escrow transaction where sender XRP Ledger allows sender to send conditional XRP payments. These conditional payments, called escrows, set aside XRP on the sender's account and deliver it later when certain conditions are met. Conditions to successfully finish an escrow include time-based unlocks and crypto-conditions. Escrows can also be set to expire if not finished in time. The XRP set aside in an escrow is locked up. No one can use or destroy the XRP until the escrow has been successfully finished or canceled. Before the expiration time, only the intended receiver can get the XRP. After the expiration time, the XRP can only be returned to the sender.

To send an escrow, the sender uses an EscrowCreate transaction to lock up some XRP. This transaction defines a finish time, an expiration time, or both. The transaction may also define a crypto-condition that must be fulfilled to finish the escrow. This transaction must define an intended recipient for the XRP; the recipient may be the same as the sender. After Escrow transaction has been processed, the XRP Ledger has an Escrow object that holds the escrowed XRP. This object contains the properties of the escrow as defined by the transaction that created it. If this escrow has a finish time, no one can access the XRP before then. The recipient, or any other XRP Ledger address, sends an EscrowFinish transaction to deliver the XRP. If the correct conditions are met, this destroys the Escrow object in the ledger and credits the XRP to the intended recipient. If the escrow has a crypto-condition, this transaction must include a fulfillment for that condition. If the escrow has an expiration time that has already passed, the EscrowFinish transaction instead fails with the code tecNO_PERMISSION. If the escrow has an expiration time, and it has not been successfully finished before then, the escrow is considered expired. It continues to exist in the XRP Ledger, but can no longer successfully finish. Expired objects remain in the ledger until a transaction modifies them. Time-based triggers cannot change the ledger contents. The sender, or any other XRP Ledger address, sends an EscrowCancel transaction to cancel the expired escrow. This destroys the Escrow object in the ledger and returns the XRP to the sender.

The Escrow Transaction API in XRP Ledger is thus used to create Bond Action 700, wherein an Bond Escrow object is created on the Lien sender's account to initiate Lien Action.

But in normal transactions, payment senders, financiers, lenders or service providers before payment are the risk bearers, digital asset based direct payment process must provide a reliable remedy as quickly as possible in order to reverse a fraudulent transaction. In a fraudulent payment transaction, the payer (sender) usually is the one who has the immediate knowledge of the fraud, and is at the best and unique position to act fast to prevent the fraudulent receiver account from removing funds out of its ledger. Decentralized Lien Action offers a decentralized solution.

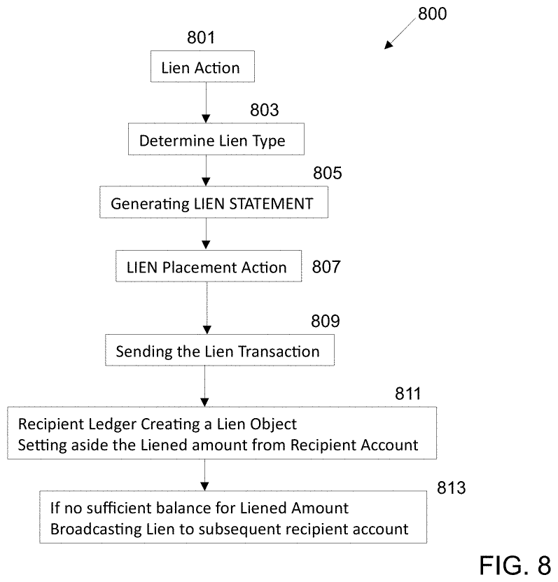

In reference to FIG. 8, a transaction oriented Lien Action system 800 that are available to all types of payers. As shown in FIG. 4, there are two main categories of payment, one is direct payment without receiver's payback, one is a loan type of payment that requires the receiver's payback at a later time. At Lien Action is initiated by a Bond Action, at step 803, the Lion Object at the Lien sender side determines what Lien Type the transaction involves. If a transaction is a direct payment, the sender should identify the Lien as Payer-Lien, and when a Payer-Lien Statement is sent to the Lienee side, the Lienee's ledger will create a Payer-Lien Object based on the properties of Escrow object on its account to set aside the amount identified in the Payer-Lien into the Escrow account, the amount will not be touched by any party until the Lien is released. But unlike an Escrow Object, Lienee account does not have the right to cancel Payer-Lien Object. The right to cancel any Lien Object, for both Payer-Lien Object and NON-Pay-Lien Object, lies with the Lien sender Account.

For loan type of payments, or prepayments that require a later payback by the receiver, the sender identifies the Lien as NON-Payer-Lien, and when a NON-Payer-Lien Statement is sent to the Lienee side, the Lienee's ledger will create a NON-Payer-Lien Object on its account to mark the amount identified in the NON-Payer-Lien, the amount in the NON-Payer-Lien can be used for subsequent payments but is marked with the Lien Statement.

The Lien sender is required to be careful in choosing the type of Lien. If the transaction is a direct payment type, not a loan, the sender in the memo identifies the Lien as Payer-Lien and direct payment, if this identification is wrong, for example, if the sender identifies a Payer-Lien as NON-Payer-Lien, this Lien Type will merely mark the transaction with a Lien, but will not set the Liened amount into escrow account that prevents the amount from being sent subsequently. To prevent this type error, all Loan types of payment are required to identify the payment as Loan Payment in the memo, during Lien Action, the transaction object checks to make sure the Type of Lien matches with the Type of the Payment.

Once a Lien sender issues Lien Placement command at step 809, the Lien Statement is sent to the Lien receiver rather than payment. When the Lien receiver receives the Lien Statement at step 811, it creates a corresponding with a Payer-Lien Object or NON-Payer-Lien Object if the Lien Statement identifies the payment transaction as loan and the ledger verification of the payment type confirms.

Payer-Lien Object is an Escrow Object that sets aside the amount identified by the Lien Statement. At step 813, if the Lien receiver account does not have sufficient balance to cover the Payer-Lien, Lien-Broadcasting Object is created to broadcast the Lien Statement to subsequent receiving accounts of the Lien receiver account.

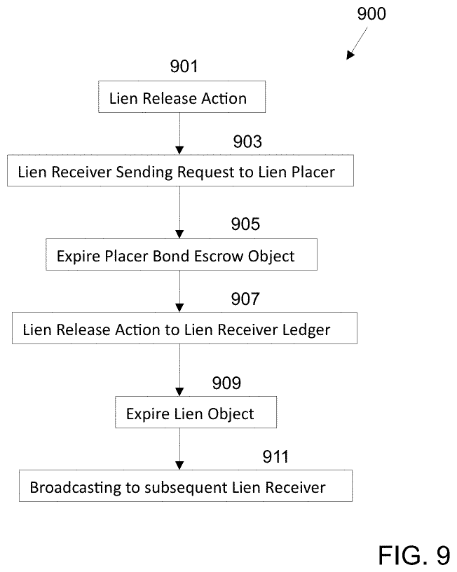

In reference to FIG. 9, Lien Release Action System 900 is shown. If a Lien recipient fulfills its obligations or conditions or settles with the issues, it can activate Lien Release Action 901 to send a request to Lien sender for releasing the Lien. The Activation process again checks the authority and Lien status, request the user to select the Lien. The Activation process checks on the current Lien Objects for the Lien recipient's account, and inquires which Lien Object be used for sending Request for Release the Lien. The Transaction Type is “Request for Release Lien”. The content information should be copied from the selected LIEN Object.

When the Lien sender receives Request for Release Lien from the Lien receiver account, and if Lien Release Action object on the Lien sender account is authorized, it expires the Bond Escrow account at step 905, and sends a Release Lien Transaction to Lien receiver ledger at step 907 which expires the Lien Object on Lien receiver account at step 909. If this Lien was broadcasted to Lien receiver's subsequent receiver accounts, the Lien Release transaction is broadcasted to the subsequent accounts at step 911.

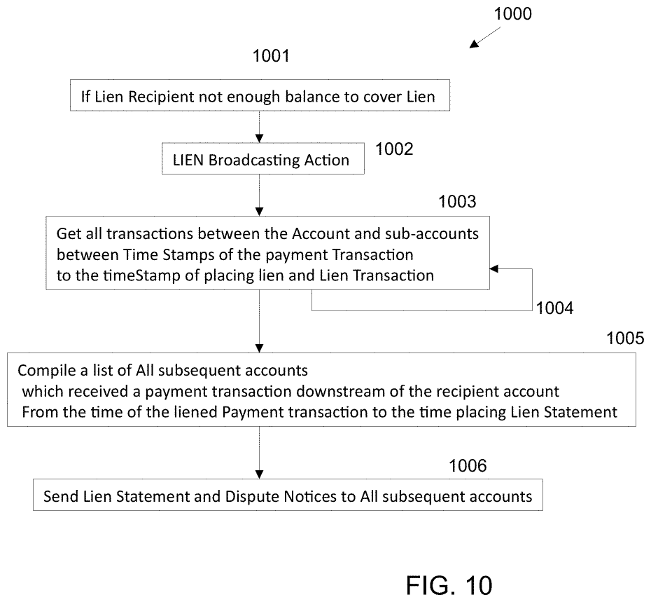

In reference to FIG. 10, a Lien-Broadcasting system 100 is shown. When a PAYER-LIEN is sent to a Lien receiver's account, Lien Action object of the receiver's account checks the total balance against the amount in the Lien Statement at step 1001. If the balance is less than the amount in the Lien Statement, Lien Broadcasting Action is activated at step 1002. At step 1003 Lien Broadcasting Action scans for all transactions between Lien receiver's account and subsequent receivers accounts for the time period between Timestamp of the payment transaction and Timestamp of the Lien Action. This step is repeated for obtaining all subsequent accounts during this period time. At step 1005, the list of subsequent accounts are compiled into a list, and at step 1006, the Lien Statement of 1001 is sent to all subsequent accounts of step 1005.

For example, if the payment recipient account has transferred the payment to another account, does not currently have sufficient balance for the LIEN, Broadcasting LIEN Action then gets History of the transactions of the recipient account, and track the subsequent transaction recipient accounts and send LIEN transactions to all the subsequent recipient accounts for the duration of time. All subsequent recipient account may activate Dispute Process to resolve the LIEN.

Any Ledger should have a Lien Receiver Action that includes a Get LIEN Action, that sends an inquiry for LIEN Transaction of the Ledger Address or an account to XRPSCAN (https://xrpscan.com/) or use the generic getTransaction. So a recipient account for accepting payment from a payer account should first check for LIEN Action history on the payer account. If there is PAYER LIEN action placed on this payer account and the entire balance of the payer account is not sufficient to cover the PAYER LIEN, the recipient account should deny the payment transaction.

```
{
  ″TransactionType″: ″LIEN ACTION″,
  ″Account″: ″rf1BiGeXwwQoi8Z2ueFYTEXSwuJYfV2Jpn″,
  ″meta″: {
    ″AffectedNodes″: [
      . . . (omitted) . . .
    ],
    ″TransactionResult″: ″tesSUCCESS″
  },
  ″validated″: true
}
```

A payer in this application includes any crypto payment sender that makes a simple and direct payment, such as a shopper, a consumer in a restaurant, and ticket buyer etc, who makes a purchase simultaneously receives the purchased items. But the payer may later dispute the product received and the service received. The most frequent frauds happen to those simple and not tech savvy type of payers who often make a lot of mistakes during the payment process.

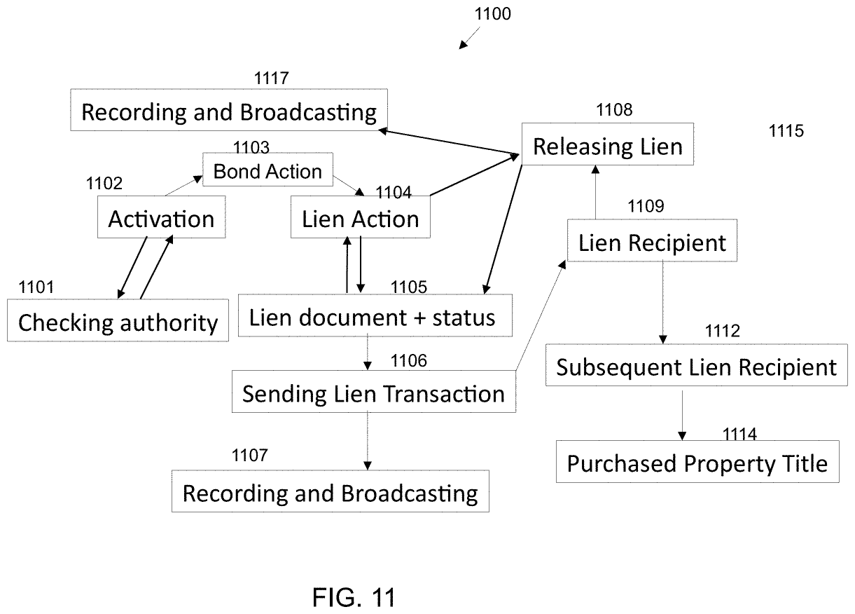

In reference to FIG. 11, an example Lien operation 1100 for direct payer 10 of FIG. 4 is shown. Direct payer 10 wants to use cryptocurrencies to make a direct payment to a retailer account 11. Checking Authority step 1101 checks to see if direct payer 10 has sufficient balance that is not claimed by Payer-Lien for making a direct payment. The ledger inquires payer 10 whether to place a PAYER-LIEN simultaneously with this payment transaction. If payer 10 is making payment first before the recipient perform its obligation, payer 10 may choose to place a Lien Statement to claim the transaction by placing a Lien Activation Bond through Bond Action 1103 to make sure the recipient will do its duty. At activation step 1102, a Lien Object is created and a LIEN ID number and LIEN Data is assigned to the Lien Statement, and Lien Action type to be as “PAYER LIEN”. Lien Object may insert the Lien Statement into a Payment Transaction, and when a successful payment transaction returns a transaction ID to payer 10 and the meta data can look like as follows:

```
      {
  ″TransactionType″ : ″Payment″,
  ″Account″: ″rMmTCjGFRWPz8S2zAUUoNVSQHxtRQD4eCx″,
  ″Destination″: ″r3kmLJN5D28dHuH8vZNUZpMC43pEHpaocV″,
  ″LIEN ACTION″: ″PAYER LIEN″
    ″LIEN STATEMENT″: [
      {
        ″LIEN STATEMENT″: {
          ″LIEN TYPE″: PAYER-LIEN,
            ″LIEN AMOUNT″: ″500″
            ″LIEN ID″:
″687474703a2f2f6578616d706c652e636f6d2f6d656d6f2f67656e65726963″,
          ″LIEN Data″: ″72656e74″
        }
      }
  ],
  ″Amount″: ″500″
}
```

At step 1107, when the ledger of recipient account 11 receives the LIEN ACTION flag “PAYER LIEN”, it creates Payer-Lien Object that sets Lien amount aside and wait for payer 10's further instruction, the amount claimed by Payer-Lien cannot be moved out of the ledger.

Generally, in a crypto-scam, the fraudsters usually would make some promises in return for the sender/payer to first send certain amount of crytos. If the Ledger provides the sender the ability to preemptively place a LIEN on the payment transaction, the fraudster recipient is prevented from moving the sender's fund out of the ledger unless and until the sender releases the Lien. The scam will fail. If the payment transaction is real, but the payer is not satisfied with a purchased product, the payer can submit this transaction for Dispute Process through the Dispute committee.

If payer 10 did not activate the Lien Action before making payment, a successful payment transaction returns a payment transaction ID to payer 10 which activates and make LIEN ACTION 1104 available to payer 10's user interface. The LIEN ACTION allows payer 10 to immediately place a “PAYER LIEN” on that payment transaction of transaction ID and to broadcast the PAYER LIEN to the receiver account's all subsequent receiver accounts during the lapsed time.

```
{
  ″TransactionType″: ″LIEN ACTION″,
  ″Account″: ″rMmTCjGFRWPz8S2zAUUoNVSQHxtRQD4eCx″,
  ″Destination″: ″r3kmLJN5D2 8dHuH8vZNUZpMC43pEHpaocV″,
  ″Transaction ID″:
″838766BA2B995c00744175F69A1B11E32C3DBC40E64801A4056FCBD657F57334″
    ″LIEN ACTION″: ″PAYER LIEN″
        ″LIEN STATEMENT″: [
          {
            ″LIEN STATEMENT″: {
              ″LIEN ID″:
  ″687474703a2f2f6578616d706c652e636f6d2f6d656d6f2f67656e65726963″,
              ″LIEN Data″: ″72656e74″
          }
        }
      ],
      ″Amount″: ″500″
}
```

When the ledger of recipient account 11 receives the LIEN Action transaction, at step 1107, it creates Payer-Lien Object that sets Lien amount aside and wait for payer 10's further instruction, the amount claimed by Payer-Lien cannot be moved out of the ledger, the Payer-Lien Object also activate Lien Broadcasting object to place the Payer-Lien on all subsequent receiver accounts.

A valid ledger is the one that recognizes Payer-Lien Action and sets the Payer-Lien claimed amount aside in the Ledger to wait for Payer-Lien holder's further instructions. Because the Lien Actions are also recorded to the blockchain, a hacker will not be able to remove the LIEN from a scammer's account.

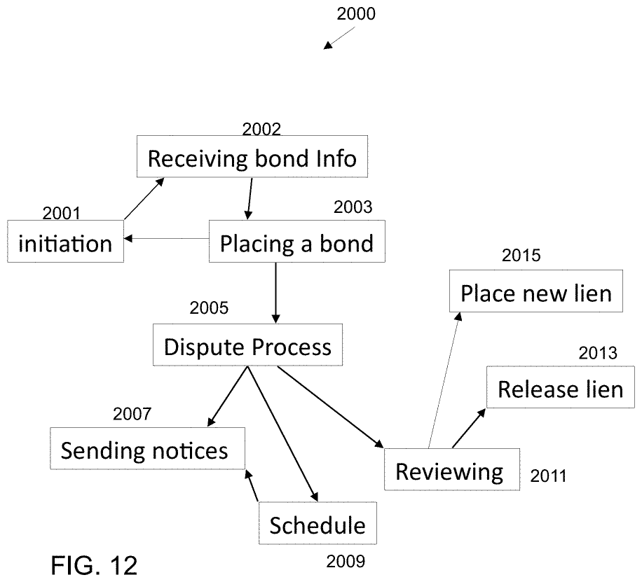

After Lien recipient 11 performs its obligation, it sends request to payer account 10 for the release of the Lien at Step 1108. Lien recipient account's available Lien Actions includes (1) “Requesting for Releasing Lien” which sends a requesting message to Payer 10 address, or (2) entering “Dispute Process” by placing a bond as shown in FIG. 12.

NON-Payer-Lien Actions are for accounts of financiers 20, lenders 30, investors 40 or service providers 50 who expect a payment recipient to pay back at a later time as shown in FIG. 4. Recipients receive loans in order to purchase other items from a subsequent party. For example, financiers 20 may finance car loans for recipients 21, or lenders 30 may underwrite mortgage loans for borrower 31 and service providers 50 may be doctors, lawyers or house builders who provide services before charging clients. In these situations, the LIEN TYPE is categorized as “NON-PAYER LIEN”. When Lien receiver account 1109 receives this type of Lien transactions, the receiver ledger will create a Lien Object that contains Non-Payer Lien Statement, the Non-Payer Lien Object keeps the ability to send the crypto-tokens to other ledgers as payment or exchange, but the LIEN STATEMENT also follows to subsequent receivers 1112 (for example, a car dealer) account. Subsequent receiver account 1112 will record the LIEN STATEMENT on the title of the financed items (the car title) in step 1114. Once the subsequent receiver account 1112 records the LIEN STATEMENT that may be on a separate title system, subsequent receiver account 1112 sends a Request to Lien Holder account at step 1115 to request Release the LIEN STATEMENT from its account.

Example NON-Payer LIEN STATEMENT may be:

“Sender Account”:“rMmTCjGFRWPz8S2zAUUoNVSQHxtRQD4eCx” place a full claim on “Destination”:

“r3kmLJN5D28dHuH8vZNUZpMC43pEHpaocV” for the transaction of “Transaction ID” until the conditions for release is satisfied.

For service providers 50, they can place a “SERVICE LIEN” to service recipients account who did not make a full payment, and to record their contract. Placing of this “SERVICE LIEN” on the receiver's account will activate the dispute process, similarly the service recipient's ledger will only record the lien on the Ledger, but will not freeze or set aside any tokens.

Alternatively, the Non-Payer Lien may be directly categorized into different types, such as “FINANCE LIEN”, “LOAN LIEN” or a “SERVICE LIEN”. Activation 1102 includes Checking Checking Authority 1101 step that checks the validity of Lien sender's ledger and the sending status, whether before a successful sending or after a successful sending, and whether the LIEN TYPE is PAYER LIEN or NON-PAYER LIEN, a “FINANCE LIEN”, “LOAN LIEN” or a “SERVICE LIEN”. The information collected at step 1101 is used for generating a LIEN STATEMENT at step 1105. NON-Payer Lien can only be placed during or after a successful loan payment transaction. The LIEN STATEMENT can include a STATUS flag, indicating the stage of the LIEN Action, whether in Recorded Status, in Dispute Process or in Released Status.

A NON-PAYER Lien Action may looks like the following:

```
{
    ″TransactionType″ : ″LIEN ACTION″,
    ″Account″: ″rMmTCjGFRWPz8S2zAUUoNVSQHxtRQD4eCx″,
    ″Destination″: ″r3kmLJN5D2 8dHuH8vZNUZpMC43pEHpaocV″,
    ″Transaction ID″:
  ″838766BA2B995C00744175F69A1B11E32C3DBC40E64801A4056FCBD657F57334″
      ″LIEN ACTION″: ″LOAN LIEN″
      ″SUBSEQUENT LIEN ACTION″: YES
      ″LIEN STATEMENT″: [
        {
          ″LIEN STATEMENT″: {
            ″LIEN ID″:
  ″687474703a2f2f6578616d706c652e636f6d2f6d656d6f2f67656e65726963″,
            ″LIEN Data″: ″72656e74″
          }
        }
      ],
      ″Amount″: ″1000″
  }
```

Function of Activation can also include collecting LIEN information before placing LIEN and collecting status information after placing LIEN, and making the information available to the Lien sender. When a user activates the Lien Action before sending a payment to a recipient, the LIEN STATEMENT can be included inside the PAYMENT transaction. When a user activates the Lien Action after successfully sending a payment which has returns a payment Transaction ID, the LIEN STATEMENT is then sent through a separate Placing Lien transaction that is similar to a Payment Transaction process, but does not send any tokens, the function just contains the related Transaction ID, the amount claimed by Lien that is related to the Transaction ID. Upon receiving the Lien Transaction, Recipient Ledger's LIEN Action is activated and the activation process is similar to the current ESCROW creation process, Recipient Ledger creates a PAYER LIEN object to place the amount under “PAYER LIEN”. But different to the Escrow account, the LIEN object is created regardless if there is sufficient balance on the LIEN receiver account. If there is no sufficient balance to cover the Payer-LIEN, the LIEN Broadcast Action will be activated to further place LIENS to the subsequent recipient accounts. This LIEN OBJECT does not have an expiration date, it is only released when the sender sends a Release Action or through the “Dispute Process”.

When the recipient's Ledger receives the Lien Action, and if the LIEN Action is a NON-Payer LIEN, it then verifies the TRANSACTION ID and creates a Lien Object that sets the amount claimed by the Lien as “NON-PAYER Lien,” the Lien receiver Ledger is still able to send this amount to other Ledgers and exchange Ledgers as payment or as exchange. This LIEN OBJECT does not have an expiration date, it is only released when the Lien sender sends a Release Action or through the “Dispute Process.”

If the Lien recipient fulfills its promises or conditions, it can activate Lien Release ACTION to send a request for RELEASE LIEN. The Activation process checks on the current Lien Objects in the Ledgers, and inquires which Lien Object to be used for sending Request for Release the Lien. The Transaction Type is “Request for Release Lien”. The content information should be copied from the selected LIEN Object. An example of such Request of release Lien Transaction Type is as follows:

```
{
    ″TransactionType″: ″REQUEST FOR LIEN RELEASE″,
    ″Account″: ″rMmTCjGFRWPz8S2zAUUoNVSQHxtRQD4eCx″,
    ″Destination″: ″r3kmLJN5D2 8dHuH8vZNUZpMC43pEHpaocV″,
    ″Transaction ID″:
  ″838766BA2B995C00744175F69A1B11E32C3DBC40E64801A4056FCBD657F57334″
      ″LIEN ACTION″: ″LOAN LIEN″
      ″SUBSEQUENT LIEN ACTION″: YES
      ″LIEN STATEMENT″: [
        {
          ″LIEN STATEMENT″: {
            ″LIEN ID″:
  ″687474703a2f2f6578616d706c652e636f6d2f6d656d6f2f67656e65726963″,
            ″LIEN Data″: ″72656e74″
          }
        }
    ],
    ″Amount″: ″1000″
  }
```

When the original Lien holder receives the request, upon verification, they can activate a Release LIEN ACTION for releasing the LIEN object in the recipient's Ledger. Depends on the LIEN TYPE, if the LIEN is about purchasing an item, such as a car, SUBSEQUENT LIEN ACTION for release car LIEN on the item is also authorized.

```
{
    ″TransactionType″: ″LIEN RELEASE″,
    ″Account″: ″rMmTCjGFRWPz8S2zAUUoNVSQHxtRQD4eCx″,
    ″Destination″: ″r3kmLJN5D2 8dHuH8vZNUZpMC43pEHpaocV″,
    ″Transaction ID″:
  ″838766BA2B995C00744175F69A1B11E32C3DBC40E64801A4056FCBD657F57334″
      ″LIEN ACTION″: ″LOAN LIEN″
      ″SUBSEQUENT LIEN RELEASE″: YES
      ″LIEN STATEMENT″: [
        {
          ″LIEN STATEMENT″: {
            ″LIEN ID″:
  ″687474703a2f2f6578616d706c652e636f6d2f6d656d6f2f67656e65726963″,
            ″LIEN Data″: ″72656e74″
          }
        }
    ],
    ″Amount″: ″1″
  }
```

In reference to FIG. 12, a Lien Dispute Process system 2000 is described. When Lien holder and Lien receiver have disagreement, they can activate this process. Initiation 2001 of Dispute process requires the initiator to first place a Bond through the Bond Action process 2002 and 2003, which sets up an ESCROW object and bond value on the initiator's account. However, the Destination Address should be the Dispute Committee's address, the bond will be held until the dispute is resolved. Bond may be made in any kind of currencies in order to allow the Dispute Initiator to start the process quickly. Example Bond Action for Dispute Process may be as follows:

```
{
    ″TransactionType″: ″BOND ACTION″,
    ″Account″: ″rMmTCjGFRWPz8S2zAUUoNVSQHxtRQD4eCx″,
    ″Destination″: ″r3kmLJN5D2 8dHuH8vZNUZpMC43pEHpaocV″,
    ″Transaction ID″:
  ″838766BA2B995C00744175F69A1B11E32C3DBC40E64801A4056FCBD657F57334″
      ″LIEN ACTION″: ″PAYOR LIEN″
      ″SUBSEQUENT LIEN RELEASE″: NO
      ″LIEN STATEMENT″: [
        {
          ″LIEN STATEMENT″: {
              LIEN ID″:
  ″687474703a2f2f6578616d706c652e636f6d2f6d656d6f2f67656e65726963″,
              ″LIEN Data″: ″72656e74″
          }
        }
    ],
    ″Amount″: ″100″
  }
```

Dispute Process 2005 further includes Notice Action 2007, Scheduling Action 2009 and Review Action 2011. Once the Escrow account is established, and the Dispute Initiator then creates a “Dispute Process” object to send notices to other parties' addresses, and sends Request for dispute to the Dispute Committee. Once a confirmation is received from the Dispute Committee, the Dispute Initiator can communicate to the Dispute Committee through email and other means. All parties accounts will receive a notice for dispute and will receive the scheduling information from the Dispute Committee. The results of Dispute Process may release old Lien 2013 and place a new Lien at step 2015.

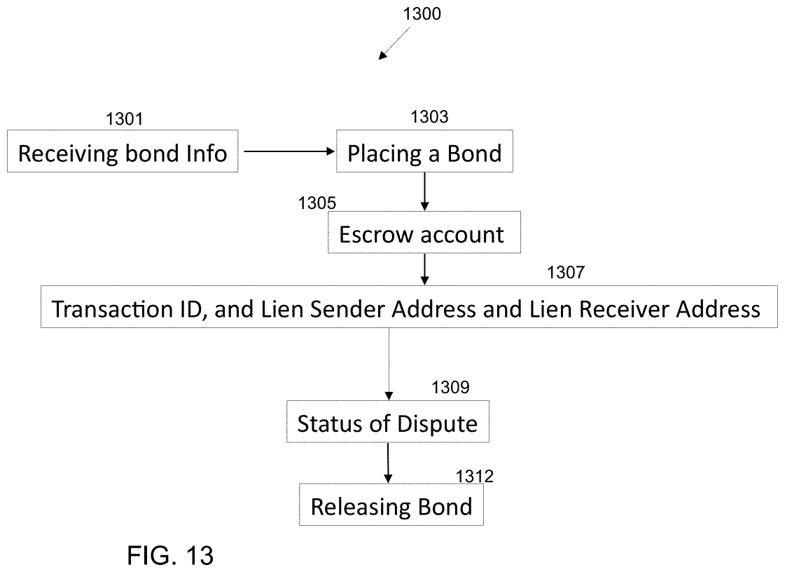

In reference to FIG. 13, the Bond Action 1300 for Dispute Process may require a calculation of Bond required at the step 1301 that is based on the disputed amount. Dispute initiator is then required to place the Bond at 1303 with any currency into an escrow account 1305 which contains all the account information, disputed transaction ID and Lien action Transaction ID, and the Bond objects will periodically update the status of Dispute at step 1309. The Bond can only be released by the Dispute committee at step 1312.

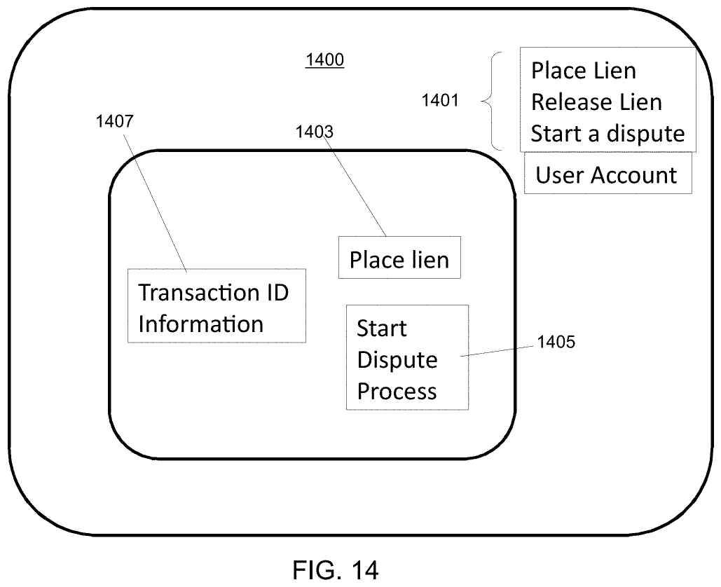

In reference to FIG. 14, an example user interface 1400 for Lien Action is described. The interface includes global actions 1401 for placing Lien and releasing Lien for all transactions conducted by the user account, it also provides a direct access one Payment Transaction with successful transaction ID 1407 to Place Lien 1403 and Dispute process 1405. Clicking on Place Lien 1403 activates the LIEN Action process in relation to the payment action 1407, including a BOND action described above, which automatically includes transaction information associated with the shown transaction ID. Clicking on Start Dispute Process 1405 activates the Dispute process described above, including a BOND action described above, which automatically includes transaction information associated with the shown transaction ID.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

1. A digital blockchain fraud-preventing lien-processing-function system for a digital blockchain token computing network ledger system, comprising:
a plurality of computing processors for processing computer actions described herein;
a computing device network of digital-currency computing ledger devices comprising a Lien-Sender-Account computing device and a Lien-Receiver-Account computing device wherein said Lien-Sender-Account computing device and Lien-Receiver-Account computing device communicate electronically through said computing device network; and
a LIEN-like-Action computing module being implemented on each of the computing ledger devices in the computing network, the Lien-like-Action computing module being configured to place a restriction computing object on said Lien-Receiver-Account computing device upon said Lien-Sender-Account computing device sends digital tokens to said Lien-Receiver-Account computing device;
wherein for sending a Lien-like action, the LIEN-like Action computing module on the Lien-Sender-Account computing device generates a LEIN-like TYPE computing object and a LIEN-like STATEMENT computing object that specifies a claimed digital token amount, and sends the Lien-like Type computing object and the LIEN-like STATEMENT computing object to the Lien-Receiver-Account computing device;
upon receiving the LIEN-like STATEMENT computing object, the LIEN-like Action computing module on the Lien-Receiver-Account computing device creates a restriction computing Object that withholds a digital token amount smaller or equal to the claimed digital token amount specified in the LIEN-like STATEMENT computing object received on the Lien-Receiver-Account computing device.

2. The digital blockchain fraud-preventing lien-like system of claim 1, wherein the LIEN-like TYPE computing object is a Payer-Lien-like Type computing object wherein for the Payer Lien-like Type transaction, the digital token amount withheld by the computing Lien-like Object on the Lien-Receiver-Account computing device is not allowed to be sent for any subsequent actions by the Lien-Receiver-Account computing device.

3. The digital blockchain fraud-preventing lien-like system of claim 1, wherein the LIEN-like TYPE computing object is a NON-Payer LIEN-like Type computing object wherein for the NON-Payer Lien-like Type transaction, the digital token amount withheld by the computing Lien-like Object on the Lien-Receiver-Account computing device is allowed to be used with the LIEN-like STATEMENT computing object for any subsequent transactions by the Lien-Receiver-Account computing device.

4. The digital blockchain fraud-preventing lien-like system of claim 1, further comprising a Bond-like Action computing module on each of the computing ledger devices in the computing network, wherein before sending a Lien-like transaction, the Lien-Sender-Account computing device creates a computing Escrow-like Object and place a Bond-like computing object in a type of digital token into said computing Escrow-like Object.

5. The digital blockchain fraud-preventing lien-like system of claim 4, further comprising a Dispute-Process-Action computing module on each of the computing ledgers devices in the computing network, wherein once the Lien-like Action computing module is activated, the Dispute-Process-computing module is also activated through placing a amount of digital token into a Bond-like Action computing module.

6. The digital blockchain fraud-preventing lien-like system of claim 1, further comprising a Lien-Release-like Action computing module on each of the computing ledger devices in the computing network, wherein upon receiving a Lien-Release-like Request computing object from the Lien-Receiver-Account computing device, the Lien-Sender-Account computing device sends the Lien Release-like action computing object to the Lien-Receiver-Account computing device that cancels or modifies the computing Lien-like Object on the Lien-Receiver-Account computing device.

7. The digital blockchain fraud-preventing lien-like system of claim 2, further comprising a Lien Broadcasting-like Action computing module on each of the computing ledger devices in the computing network, wherein for the Payer Lien-like Type transaction, if the Lien-Receiver-Account computing device has an unclaimed balance by a Payer-Lien-like computing object that is less than the claimed digital token amount specified in the LIEN-like STATEMENT computing object, the computing Lien-like Object creates a Lien Broadcasting-like Computing Object that scans for all transactions and subsequent transactions that occurred during a time between the a digital token received and the Lien-like Transaction from the Lien-Receiver-Account computing device.

8. The digital blockchain fraud-preventing lien-like system of claim 3, wherein a subsequent Lien-Receiver-Account computing device in the computing network of the Lien-Receiver-Account computing device is enabled to send a Lien Release-like Request computing object to the Lien-Sender-Account computing device.

9. The digital blockchain fraud-preventing lien-like system of claim 2, further comprising a token-sending Transaction computing module that determines, before sending a digital token amount from a sender device in the computing network, whether the sender device has a balance by a Payer-Lien-like computing object that is bigger or equal to the digital token amount.

10. A method of preventing fraud in a digital blockchain token computing network ledger system having a network of computing ledger devices, comprising the actions of:
providing a LIEN-like Action computing module implemented on each of the computing ledger devices in the computing network, the Lien-like Action computing module being configured to place claim computing objects over a successful digital token amount sent;
for a digital token sending transaction from a Sender Account computing device to a Receiver account computing device, the Sender Account computing device sending a Lien-like transaction computing object comprising a Payer-LEIN-like TYPE computing object and a LIEN-like STATEMENT computing object that claims the digital token amount on the Receiver Account computing device;
upon receiving the LIEN-like STATEMENT computing object, the LIEN-like Action computing module on the Receiver account computing device creates a computing LIEN-like Object that withholds a digital token amount smaller or equal to the digital token amount specified in the LIEN-like STATEMENT computing object.

11. The method of claim 10, further comprising the step of providing a Lien Broadcasting-like Action computing module on each of the computing ledger devices in the computing network, if the Receiver Account computing device has an unclaimed balance by a Payer-Lien-like computing object that is less than the claimed digital token amount specified in the LIEN-like STATEMENT computing object, the computing Lien-like Object on the Receiver Account computing device creates a computing Lien Broadcasting-like Object that scans for all transactions and subsequent transactions that occurred during the time between receiving a digital token transaction and the Lien-like Transaction from the Receiver Account computing device.

12. The method of claim 10, further comprising the step of the creating a computing Escrow-like Object for hold a Bond-like amount digital tokens for the Sender computing device before the sender sending a Lien-like Transaction computing object.

13. The method of claim 10, further comprising the step of the creating a computing Escrow-like Object for holding a Bond-like amount of digital tokens before creating a computing Dispute-like Object to start a Dispute Process computing module.
